(19) United States
(12) Patent Application Publication
(10) Pub. No.: US 2006/0064758 A1
(43) Pub. Date: Mar. 23, 2006

(54) Method for preventing piracy of computer software

(76) Inventors: Joe Petner, Manalapan, NJ (US); Michael Mitrosky, South Amboy, NJ (US)

Correspondence Address: Arthur M. Peslak, Esq.;MANDEL & PESLAK, LLC, Suite 5, 80 Scenic Drive, Freehold, NJ, 07728, US

(21) Appl. No.: 10/946,990

(22) Filed: Sep. 22, 2004

(51) Int. Cl. H04N 7/16

(52) U.S. Cl. 726/26

(57) ABSTRACT

Computer Software and a method is disclosed for enabling owners of software products to protect the property rights of their software. The system and method utilize a unique system to identify each instance of illegal installation of a specific software product. The system will alert owners of software products being illegally installed and/or executed onto computers.

### BACKGROUND OF THE INVENTION

Software piracy is the activity of using or making illegal copies of software or information without the authorization of the creator or legitimate owner of that software. With the advent of the internet, software piracy has become rampant and is generally viewed as an unstoppable force in facilitating the distribution and copying of illegal software and information worldwide.

Although there have been a number of attempts at stopping piracy, they have met with little success. These include the following: Software Identification Keys, hardware lockout mechanisms, passwords derived from accompanying documentation, and unique floppy or CD-Rom formats that are not easily reproduceable.

The common thread in all of these types of protection techniques is that they attempt to stop piracy by preventing it or deterring it by such means as making it too time consuming or difficult for the average software user to “crack”. The ‘average user’ is the main beneficiary of illegally copied software. However, with the advent of the internet and peer-to-peer communications, ‘average users’ no longer have to ‘crack’ software themselves. Most hackers and pirates generally can look through a program and remove any and all included software/hardware anti-piracy measures. This is the reason why the available protection techniques have always failed. But now with the ability to transfer software worldwide over the internet at high speed baud rates and sharing them on a peer-to-peer medium for example, pirated software and information can be duplicated literally thousands of times every minute of every hour of the day, 24 hours a day, 7 days a week.

What is clearly needed is not a system to prevent users from pirating software, but a system to alert the owners of software when their programs are being pirated, as they are being pirated. An analogy in comparison can be seen in the automobile industry and the use of car alarms. A lot of people have car alarms yet car thefts have continued unabated for years. And although the presence of a car alarm might deter an inexperienced thief [average computer user], it will not prevent theft by an experienced car thief [computer pirate/hacker]. The answer to this plight has been the creation and use of the Lojack® system used nationwide by police. Lojack® tracks down and locates a stolen auto only after it is stolen. The present invention similarly acts like a Lojack® system for software and digital information.

Before modems made networking computers simple, the common software user was limited to distributing copies basically to friends and associates in his or her own social circle. Copies were basically distributed and traded between co-workers, neighbors, and friends.

When the use of modems first became popular, pirates extended their reach by being able to upload their pirated software onto computer bulletin board systems. Each time a new user logged on to the bulletin board he or she was free to upload and download new pirated software as it became available. This enabled the average computer user to obtain illegal copies of software over long distances for the first time. Anywhere you could dial a phone to, conceivably was also a place you could copy software from. The limitation on this type of system however is that, long distance phone calls were expensive, transfer speeds of modems were much slower, and only one person could be logged on at a time. This kept the size of pirated files relatively small, the length of the call relatively short and while a user was logged in and downloading illegal software, nobody else could do so.

As the years passed and technological improvements were made in the speed of modems, it became practical to introduce the world wide web section of the internet to the general public. This technological advance immediately removed the 3 limitations of the bulletin board system for now phone calls were essentially free (flat rate internet access), file size was only limited to the size of your hard drive, and multiple users could access the same files at the same time anywhere in the world. There was no stopping piracy at this point. Essentially, if someone wanted to illegally copy a big software file, that person could simply stay connected to the internet all day or night and another free piece of stolen software was downloaded. And while one user was accessing that file, other users were free to download that same software as well.

A peer-to-peer network is basically one large group of computers users with essentially one goal—the sharing and distribution of software, music, videos, and documents—really any and all types of digital data and information. Every user in the peer-to-peer network has to share their own collection of shared folders or software, music, video, etc. In exchange, each person has access to every other user's collection of shared folders in the network.

### SUMMARY OF THE INVENTION

It is an object of the present invention to provide means for tracking the illegal copying of software. This object is met by the invention as claimed. In particular the present invention is directed to a method and software for tracking the installation of illegally pirated software whereby Tracking Software is embedded in Host Software. When the Host Software is installed on a computer with an internet connection, the Tracking Software downloads identification information to a remote server. The remote server collects the identification information for use by the proprietors of the host Software in enforcing its propriety rights in the software.

### BRIEF DESCRIPTION OF THE DRAWINGS

FIG. 1 is a block diagram illustrating the present invention.

FIG. 2 is a block diagram illustrating a typical use of the present invention.

FIG. 3 is a block diagram illustrating use of the present invention in a peer to peer network.

### DETAILED DESCRIPTION ON THE INVENTION

The present invention will now be described in terms of the presently preferred embodiment. Those of ordinary skill in the art will recognize that many modifications may be made thereto without departing from the spirit or scope of the present invention.

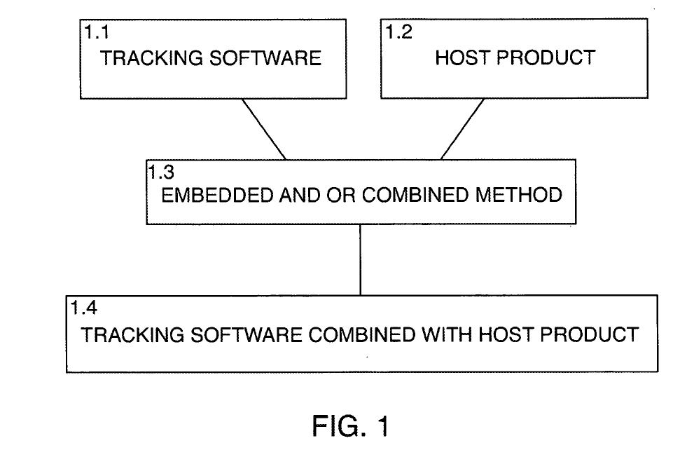

As illustrated in FIG. 1, the present invention is directed to Tracking Software that is embedded directly in other available software referred to in FIG. 1 as the Host Software. The embedding and combining of the Tracking Software with the Host Software can be accomplished by a number of means as is well known to those of ordinary skill in the art. The types of methods include but are not limited to zipping, arcing, g-zing, ISO's, disk images and standard embedded code. After the Tracking Software is embedded in the Host Software, the present invention can be utilized on any operating system or platform.

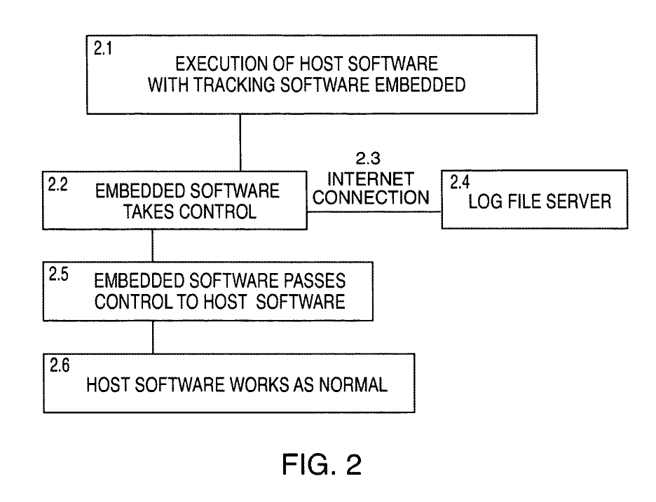

FIG. 2, illustrates the use of the present invention. As shown in block 2-1, the Host Software with embedded Tracking Software is installed on a particular computer with an internet connection. When the Host Software is installed, the Tracking Software will take control and determine whether the computer is connected to the Internet. The Tracking Software will create a log of the traceable IP address, the computer used, and the date and time of installation. The Tracking Software uses the internet connection to create a log of the installation on a remote server. The information is collected on the remote server and provided to the Host Software Company to use in appropriate civil or criminal legal actions against the users of the illegal software. After the log on the remote server is created, the Tracking Software passes control to the Host Software which then performs its normal functions.

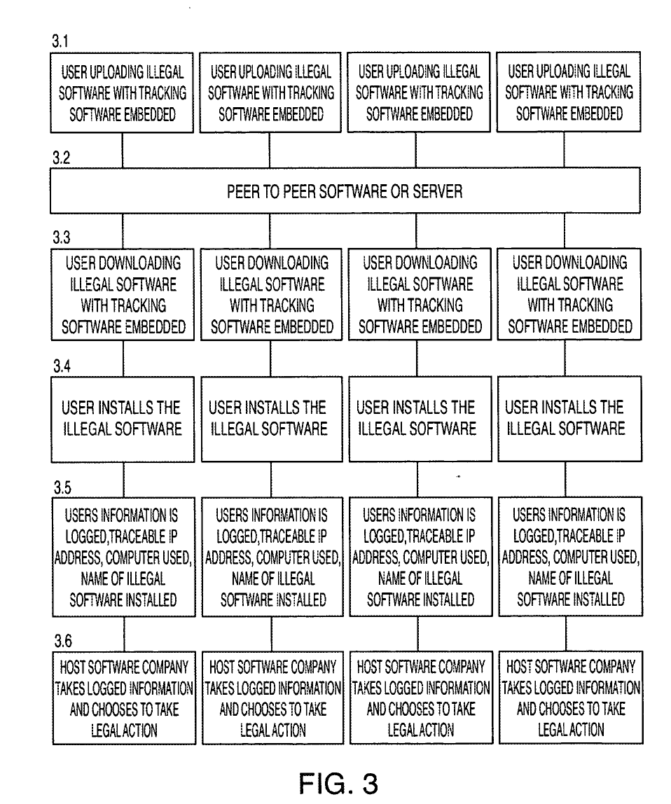

FIG. 3 illustrates the use of the present invention on a peer-to-peer network. The illustration in FIG. 3 concerns a computer user who uploads software for illegal sharing on peer-to-peer network. The uploaded software contains the embedded Tracking Software of the present invention. Once the software is uploaded to the server of the peer-to-peer network, it is available for downloading to multiple users. Once the software is downloaded to the individual users of the peer-to-peer network, the same process described in connection with FIG. 2 takes place with respect to each user's installation of the Host Software.

The software process just described can be readily adapted to any computer situation where software is illegally downloaded. Those situations include but are not limited to the World Wide Web, internet chat relay (IRC), FTP, NTTP, and electronic mail.

Those of ordinary skill in the art will recognize that the foregoing description merely illustrates an embodiment of the present invention and many modifications may be made thereto without departing from the spirit and scope of the present invention as set forth in the following claims.

What is claimed is:

1) A method for tracking the installation of illegally pirated software comprising the following steps:
a) Embedding a Tracking Software in a Host Software;
b) Actuating the Tracking Software when the Host Software is installed on a computer with an internet connection;
c) Using the internet connection to allow the Tracking Software to transmit identification information of the computer to a remote server;
d) Collecting the identification information on the remote server for retrieval and use by a proprietor of the Host Software; and
e) Allowing the Host Software to operate normally.

2) Computer Software for tracking the installation of illegally pirated Software comprising:
a) Host Software; and
b) Tracking Software embedded in the Host Software wherein the Tracking Software is actuated when the Host Software is installed onto a computer with an interact connection and thereby downloads identification information to a remote server by means of the internet connection while allowing the Host Software to operate normally.

3) A system for the collection of identification information for illegally installed computer software comprising;
a) Host Software; and
b) Tracking Software embedded in the Host Software wherein the Tracking Software is actuated when the Host Software is installed onto a computer with an internet connection and thereby downloads identification information to a remote server by means of the internet connection while allowing the Host Software to operate normally.

3) A system for the collection of identification information for illegally installed computer software comprising;
a) Host Software;
b) Tracking Software embedded in the Host Software wherein the Tracking Software is actuated when the Host Software is installed onto a computer with an internet connection and thereby downloads identification information to a remote server by means of the internet connection while allowing the Host Software to operate normally; and
c) A remote server connected to the internet for collection and retrieval of the identification information.
